(19) United States
(12) Patent Application Publication
(10) Pub. No.: US 2017/0194839 A1
(43) Pub. Date: Jul. 6, 2017

(54) Motor And Airflow Generating Device

(71) Applicant: Johnson Electric S.A., Murten (CH)

(72) Inventors: James Ching Sik LAU, Hong Kong (CN); Bei Bei HE, Shen Zhen (CN); Hong Jiang ZHAO, Shen Zhen (CN); Ying Song YE, Shen Zhen (CN)

(21) Appl. No.: 15/397,112

(22) Filed: Jan. 3, 2017

(30) Foreign Application Priority Data
Dec. 31, 2015 (CN) 2015 1103 1190.4

(51) Int. Cl. H02K 9/06; H02K 1/27; H02K 1/12; H02K 5/20

(52) U.S. Cl. CPC H02K 9/06; H02K 5/20; H02K 1/2706; H02K 1/2786; H02K 1/12

(57) ABSTRACT

A motor and an airflow generating device using the motor are provided. A stator of the motor includes a barrel-shaped core with a stator winding wound therearound. A rotor of the motor includes outer and inner barrels, first permanent magnets mounted to the outer barrel, and second permanent magnets mounted to the inner barrel. The barrel-shaped core is located between the first and second permanent magnets. At least one of the outer and inner barrels includes first and second barrel sections that are separately formed, and the first and second barrel sections are stacked and fixed together along an axial direction of the motor. The connecting portion is integrally formed with at least a portion of the outer barrel and at least a portion of the inner barrel. This invention facilitates fabrication of the motor.

### CROSS REFERENCE TO RELATED APPLICATIONS

This non-provisional patent application claims priority under 35 U.S.C. §119(a) from Patent Application No. 201511031190.4 filed in The People's Republic of China on Dec. 31, 2015.

### FIELD OF THE INVENTION

This invention relates to driving devices, and in particular, to a motor and an airflow generating device using the motor.

### BACKGROUND OF THE INVENTION

A rotor of a conventional brushless motor includes a cylindrical outer housing, and permanent magnets mounted to an inner surface of the cylindrical outer housing. The permanent magnets and stator poles interact to drive the outer housing to rotate. One problem of such motor is that the performance of the motor is limited by the number of the permanent magnets.

### SUMMARY OF THE INVENTION

One aspect of the present invention provides a motor including a stator and a rotor rotatably mounted with respect to the stator. The stator comprises a barrel-shaped core and a stator winding wound around the barrel-shaped core. The rotor comprises a rotary shaft, an outer barrel fixed to the rotary shaft, an inner barrel fixed to the rotary shaft, first permanent magnets mounted to an inner surface of the outer barrel, and second permanent magnets mounted to an outer surface of the inner barrel. The barrel-shaped core is located between the first permanent magnets and the second permanent magnets. At least one of the outer barrel and the inner barrel comprises a first barrel section and a second barrel section that are separately formed, and the first barrel section and the second barrel section are stacked and fixed to each other along an axial direction of the motor.

Preferably, an end portion of the outer barrel and an end portion of the inner barrel are interconnected by a connecting portion.

Preferably, the connecting portion is integrally formed with at least a portion of the outer barrel and at least a portion of the inner barrel.

Preferably, the connecting portion is of a planar annulus having an outer edge connected to the outer barrel and an inner edge connected to the inner barrel.

Preferably, the inner barrel includes the first barrel section and the second barrel section that are stacked along the axial direction of the motor, and the first barrel section, the connecting portion and the outer barrel are integrally formed.

Preferably, the outer barrel includes the first barrel section and the second barrel section that are stacked along the axial direction of the motor, and the first barrel section, the connecting portion and the inner barrel are integrally formed.

Preferably, the rotor comprises a connecting structure fixed to the rotary shaft, and the outer barrel and the inner barrel are fixed to the connecting structure.

Preferably, the connecting structure comprises a circular disc-shaped connecting plate and a hub disposed at a center of the connecting plate, the hub is fixed to the rotary shaft, and the outer barrel and the inner barrel are fixed to the connecting plate.

Preferably, an end portion of the outer barrel and an end portion of the inner barrel are connected through a connecting portion and are fixed to the connecting plate through the connecting portion.

Preferably, the stator comprises a fixing bracket, the fixing bracket comprises a bearing seat, the rotary shaft is rotatably mounted to the bearing support through bearings, and the barrel-shaped core and the stator winding are fixed to the fixing bracket and surround the bearing seat.

Preferably, two axial ends of the barrel-shaped core are mounted with two annular spacers, respectively, and the barrel-shaped core and the stator winding are isolated from each other by the annular spacers.

Another aspect of the present invention provides an airflow generating device using the above motor. An impeller of the airflow generating device is fixedly mounted to the rotor of the motor and is rotatable along with the rotor.

Preferably, the rotor comprises a rotary shaft, the impeller comprises a mounting base, a plurality of vanes surrounding the mounting base, a connecting member interconnecting the mounting base and the plurality of vanes, and the mounting base is fixed to the rotary shaft.

Preferably, the connecting member is an umbrella-shaped connecting plate, two ends of each of the plurality of vanes are connected to a first ring portion and a second ring portion, and the second ring portion is connected to an outer end of the umbrella-shaped connecting plate.

Preferably, the connecting member further comprises a barrel portion, the barrel portion surrounding an outer circumference of the outer barrel of the motor rotor.

In the motor of the present invention, the stator winding is wound around the barrel-shaped stator core, which results in a compact structure. The rotor includes the outer barrel and the inner barrel, and the inner surface of the outer barrel and the outer surface of the inner barrel are both mounted with permanent magnets. Therefore, the number of the permanent magnets is increased, which leads to enhanced motor performance. In addition, one of the outer barrel and the inner barrel includes two barrel sections that are separately formed, which facilitates fabrication of the outer barrel or inner barrel and facilitates improving coaxiality between the outer barrel and the inner barrel.

Below, embodiments of the present invention will be described in detail with reference to the accompanying drawings.

### BRIEF DESCRIPTION OF THE DRAWINGS

FIG. 1 illustrates an airflow generating device according to one embodiment of the present invention.

FIG. 2 is a sectional view of the airflow generating device of FIG. 1.

FIG. 3 is a sectional view of a motor used in the airflow generating device of FIG. 1.

FIG. 4 is a sectional view of a rotor of the motor of FIG. 3.

FIG. 5 illustrates an impeller used in the airflow generating device of FIG. 1.

FIG. 6 is a sectional view of the impeller of FIG. 5.

### DETAILED DESCRIPTION OF THE PREFERRED EMBODIMENTS

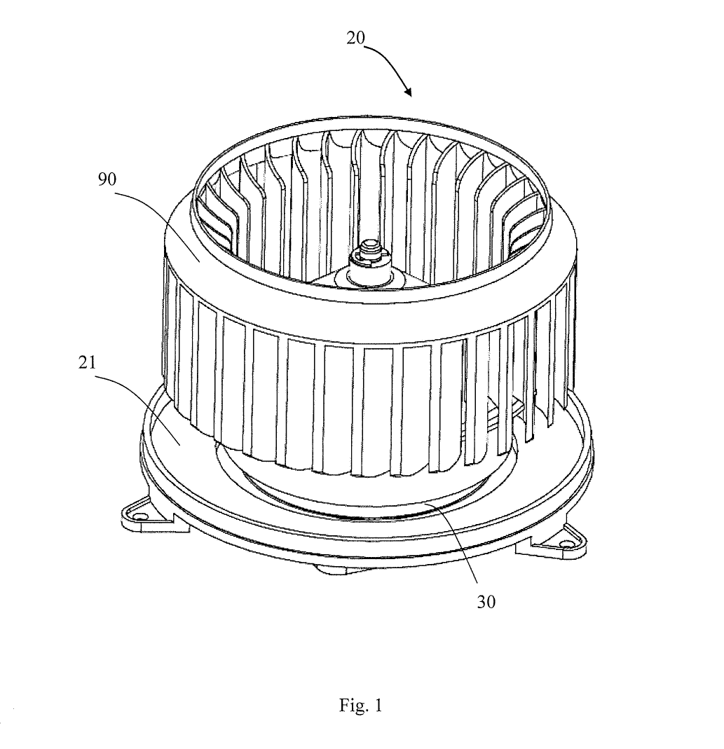

Referring to FIG. 1, an airflow generating device in accordance with one embodiment of the present invention provides a mounting bracket 21, a motor 30 mounted to the mounting bracket 21, and an impeller 90 to be driven by the motor 30.

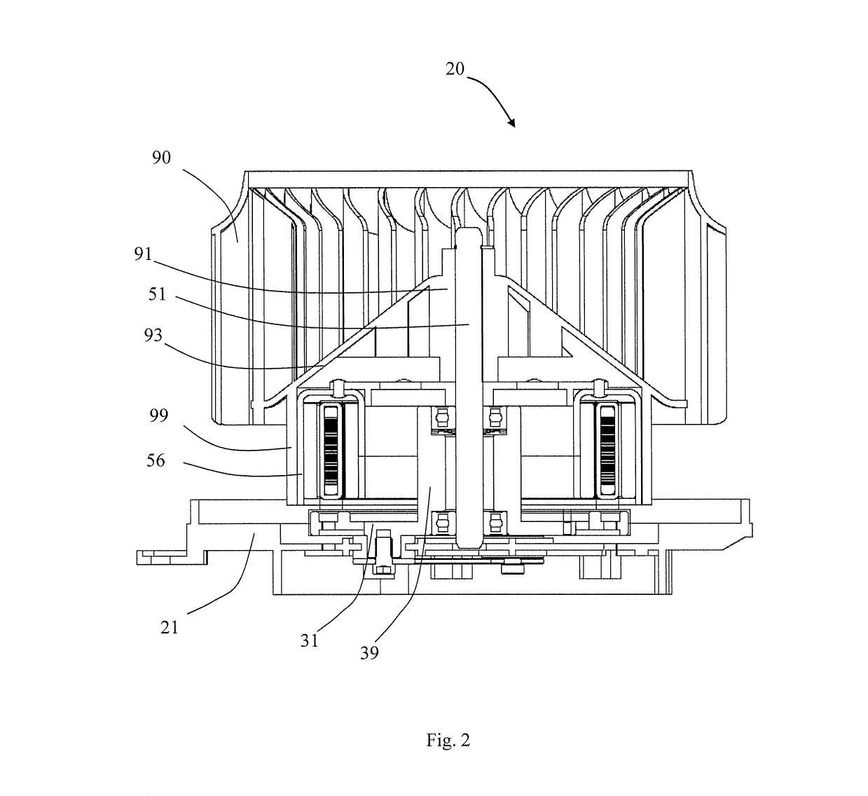

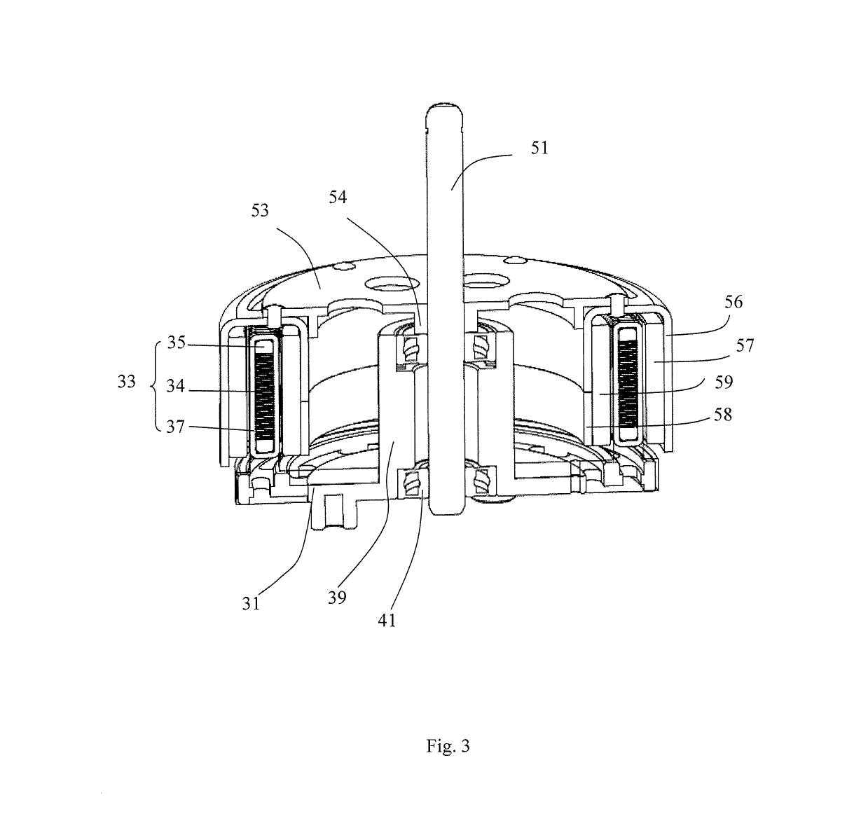

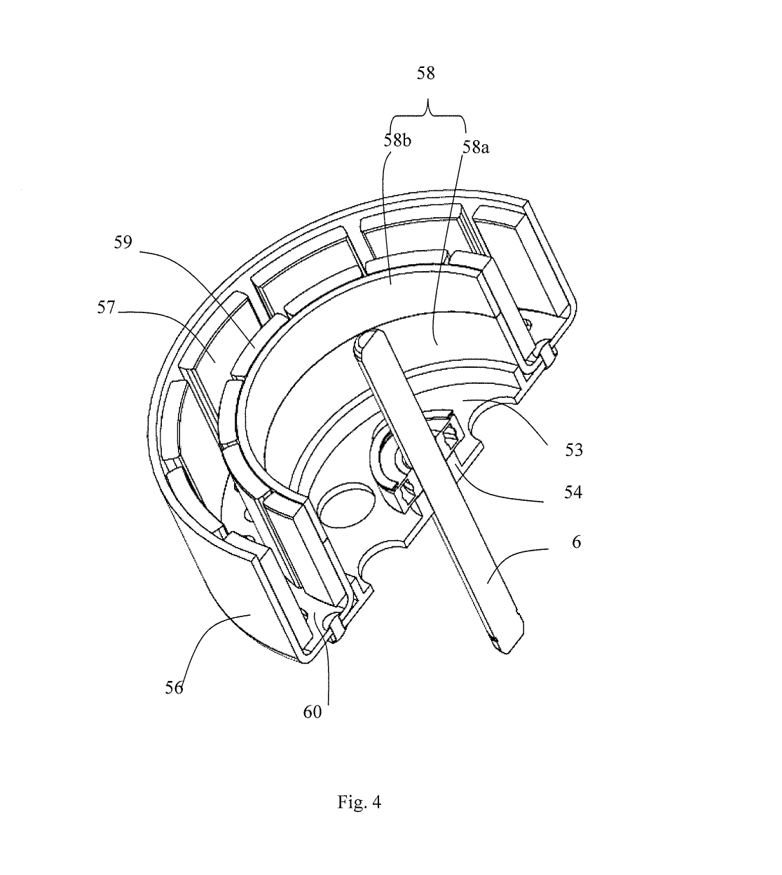

Referring to FIG. 2 to FIG. 4, the motor 30 includes a stator and a rotor rotatably mounted with respect to the stator. The stator includes a fixing bracket 31, a barrel-shaped core 34, a stator winding 37 wound around the barrel-shaped core 34. The fixing bracket 31 is fixed to the mounting bracket 21 with screws. The fixing bracket 31 includes a bearing seat 39 at a center thereof. Two ends of the bearing seat 39 are mounted with rolling bearings 41. The barrel-shaped core 34 surrounds the bearing seat 39. Two annular insulating spacers 35 are mounted on two axial ends of the barrel-shaped core 34, respectively, such that the barrel-shaped core 34 and the stator winding 37 are isolated from each other by the annular insulating spacers 35. The barrel-shaped core 34, annular insulating spacers 35 and stator winding 37 are as a whole fixed to the fixing bracket 31 by, for example, injection molding.

A rotary shaft 51 of the rotor is mounted to the bearing seat 39 through the support of the bearings 41, such that the rotor is rotatable relative to the stator. The rotor includes an outer barrel 56 and an inner barrel 58 surrounding the rotary shaft 51, first permanent magnets 57 mounted to an inner surface of the outer barrel 56, and second permanent magnets 59 mounted to an outer surface of the inner barrel 58. The annular core 34 is disposed between the first permanent magnets 57 and the second permanent magnets 59. The outer barrel 56 and the inner barrel 58 are fixedly connected to the rotary shaft 51 by a connection structure, so as to be rotatable relative to the stator.

In this embodiment, the connection structure includes a circular disc-shaped connecting plate 53 and a hub 54 disposed at a center of the connecting plate 53. The hub 54 is fixed to the rotary shaft 51, and the outer barrel 56 and the inner barrel 58 are fixed to the connecting plate 53.

In this embodiment, an end portion of the outer barrel 56 and an end portion of the inner barrel 58 are interconnected by a connecting portion 60 and are fixed to the connecting plate 53 by the connecting portion 60. The connecting portion 60 is of a planar annulus having an outer edge connected to the outer barrel 56 and an inner edge connected to the inner barrel 58. Preferably, the connecting portion 60 is integrally formed with at least a portion of the outer barrel 56 and at least a portion of the inner barrel 58, so that the outer barrel 56 and the inner barrel 58 are fixed to the connecting plate 53 through the connecting portion 60. For example, the connecting portion 60 is fixed to the connecting plate 53 with screws.

In this embodiment, the inner barrel 58 includes a first barrel section 58a and a second barrel section 58b that are separately formed. The first barrel section 58a and the second barrel section 58b are stacked and fixed to each other along an axial direction of the motor, and the first barrel section 58a, the connecting portion 60, and the outer barrel 56 are integrally formed. The integral forming of the first barrel section 58a, the connecting portion 60, and the outer barrel 56 is advantageous in that it facilitates the fixing of the first barrel section 58a and the outer barrel 56 to the connecting plate 53 through the connecting portion 60, and results in improved coaxiality between the first barrel section 58a and the outer barrel 56. That the inner barrel 58 includes the separately formed first barrel section 58a and second barrel section 58b is advantageous in that it facilitates controlling the coaxiality between the first barrel section 58a and the second barrel section 58b. If the entire outer barrel 56, the inner barrel 58, and the connecting portion 60 are integrally formed by, for example, a drawing process, the coaxiality between the outer barrel 56 and the connecting portion 60 can hardly be ensured.

In an alternative embodiment, the outer barrel 56 includes a first barrel section and a second barrel section that are separately formed. The first barrel section and the second barrel section are stacked and fixed to each other along the axial direction of the motor, and the first barrel section, the connecting portion, and the inner barrel 58 are integrally formed.

Preferably, the number of the first permanent magnets 57 mounted to the inner surface of the outer barrel 56 is the same as the number of the second permanent magnets 59 mounted to the outer surface of the inner barrel 58. The permanent magnets 57, 59 are all radially polarized. Each permanent magnet 57 is opposed to one corresponding permanent magnet 59, and two opposed faces of the permanent magnets have the same polarity, i.e. one North polarity corresponds to one North polarity, and one South polarity corresponds to one South polarity.

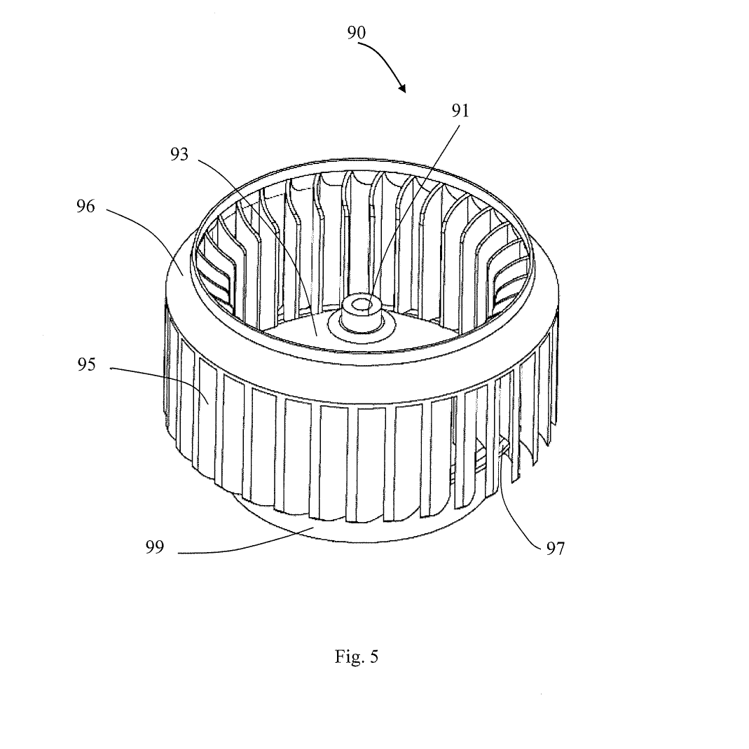

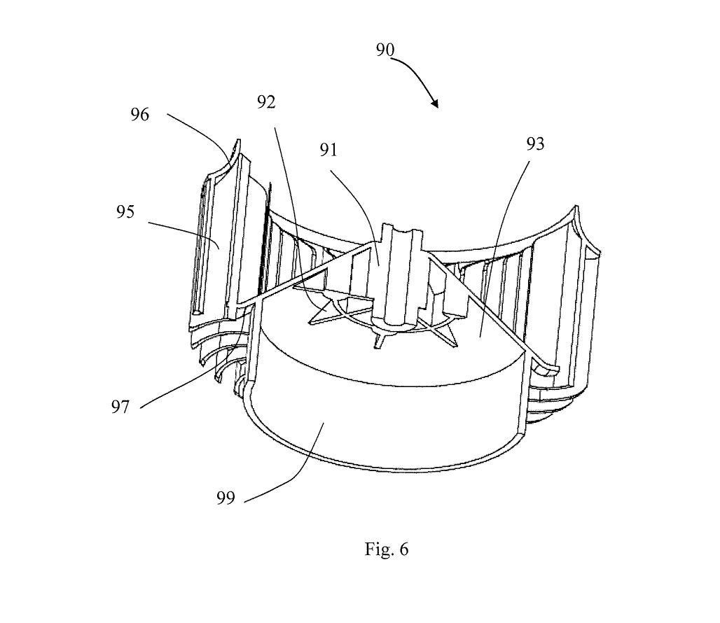

Referring to FIGS. 5 and 6, the impeller 90 includes a mounting base 91, a plurality of vanes 95 surrounding the mounting base 91, and a connecting member 93 connecting the mounting base 91 and the plurality of vanes 95. The mounting base 91 is fixed to the rotary shaft 51, such that the impeller 90 is rotatable along with the motor rotor.

The connecting member 93 is an umbrella-shaped connecting plate that is connected with the hub 91 through reinforcement ribs 92. Two ends of each vane 95 are connected to a first ring portion 96 and a second ring portion 97, respectively. The second ring portion 97 is connected to an outer end of the umbrella-shaped connecting plate.

The connecting member 93 further includes a barrel portion 99. The barrel portion 99 surrounds an outer circumference of the outer barrel 56 of the motor rotor.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A motor comprising:
a stator comprising a barrel-shaped core and a stator winding wound around the barrel-shaped core; and
a rotor rotatably mounted with respect to the stator, the rotor comprising:
a rotary shaft;
an outer barrel fixed to the rotary shaft;
an inner barrel fixed to the rotary shaft;
first permanent magnets mounted to an inner surface of the outer barrel, and
second permanent magnets mounted to an outer surface of the inner barrel, the barrel-shaped core located between the first permanent magnets and the second permanent magnets;
wherein at least one of the outer barrel and the inner barrel comprises a first barrel section and a second barrel section that are separately formed, and the first barrel section and the second barrel section are stacked and fixed to each other along an axial direction of the motor.

2. The motor of claim 1, wherein an end portion of the outer barrel and an end portion of the inner barrel are interconnected by a connecting portion.

3. The motor of claim 2, wherein the connecting portion is integrally formed with at least a portion of the outer barrel and at least a portion of the inner barrel.

4. The motor of claim 3, wherein the connecting portion is of a planar annulus having an outer edge connected to the outer barrel and an inner edge connected to the inner barrel.

5. The motor of claim 3, wherein the inner barrel comprises the first barrel section and the second barrel section that are stacked along the axial direction of the motor, and the first barrel section, the connecting portion and the outer barrel are integrally formed.

6. The motor of claim 3, wherein the outer barrel includes the first barrel section and the second barrel section that are stacked along the axial direction of the motor, and the first barrel section, the connecting portion and the inner barrel are integrally formed.

7. The motor of claim 1, wherein the rotor further comprises a connecting structure fixed to the rotary shaft, and the outer barrel and the inner barrel are fixed to the connecting structure.

8. The motor of claim 7, wherein the connecting structure comprises a circular disc-shaped connecting plate and a hub disposed at a center of the connecting plate, the hub is fixed to the rotary shaft, and the outer barrel and the inner barrel are fixed to the connecting plate.

9. The motor of claim 8, wherein an end portion of the outer barrel and an end portion of the inner barrel are connected through a connecting portion and are fixed to the connecting plate through the connecting portion.

10. The motor of claim 7, wherein the stator comprises a fixing bracket, the fixing bracket comprises a bearing seat, the rotary shaft is rotatably mounted to the bearing support through bearings, and the barrel-shaped core and the stator winding are fixed to the fixing bracket and surround the bearing seat.

11. The motor of claim 1, wherein two axial ends of the barrel-shaped core are mounted with two annular spacers, respectively, and the barrel-shaped core and the stator winding are isolated from each other by the annular spacers.

12. An airflow generating device comprising:
an impeller; and
a motor comprising:
a stator comprising a barrel-shaped core and a stator winding wound around the barrel-shaped core; and
a rotor rotatably mounted with respect to the stator, the rotor comprising a rotary shaft, an outer barrel fixed to the rotary shaft, an inner barrel fixed to the rotary shaft, first permanent magnets mounted to an inner surface of the outer barrel, and second permanent magnets mounted to an outer surface of the inner barrel, the barrel-shaped core located between the first permanent magnets and the second permanent magnets;
wherein at least one of the outer barrel and the inner barrel comprises a first barrel section and a second barrel section that are separately formed, and the first barrel section and the second barrel section are stacked and fixed to each other along an axial direction of the motor, and the impeller is fixedly mounted to the rotor of the motor and is rotatable along with the rotor.

13. The airflow generating device of claim 12, wherein the impeller comprises a mounting base, a plurality of vanes surrounding the mounting base, a connecting member interconnecting the mounting base and the plurality of vanes, and the mounting base is fixed to the rotary shaft.

14. The airflow generating device of claim 13, wherein the connecting member is an umbrella-shaped connecting plate, two ends of each of the plurality of vanes are connected to a first ring portion and a second ring portion, and the second ring portion is connected to an outer end of the umbrella-shaped connecting plate.

15. The airflow generating device of claim 13, wherein the connecting member further comprises a barrel portion, the barrel portion surrounding an outer circumference of the outer barrel of the motor rotor.
